(19) United States
(12) Patent Application Publication
(10) Pub. No.: US 2025/0080899 A1
(43) Pub. Date: Mar. 6, 2025

(54) HYBRID DUAL UNIT EARPHONE

(71) Applicant: Guoguang Electric Company Limited, Guangzhou (CN)

(72) Inventors: Dezhi Huang, Guangzhou (CN); Zhenhua Liu, Guangzhou (CN); Xintai Geng, Guangzhou (CN); Weixing Cen, Guangzhou (CN)

(21) Appl. No.: 18/952,614

(22) Filed: Nov. 19, 2024

(30) Foreign Application Priority Data
May 29, 2024 (CN) 202421196853.2

(51) Int. Cl. H04R 1/24; H04R 1/02; H04R 1/10; H04R 1/26; H04R 1/32

(52) U.S. Cl. CPC H04R 1/24; H04R 1/023; H04R 1/1075; H04R 1/26; H04R 1/323; H04R 2201/003

(57) ABSTRACT

The present disclosure relates to the technical field of earphone equipment, and describes a hybrid dual unit earphone, comprising an earphone casing, an inside cavity arranged in the earphone casing, a sound output port configured to communicate with the inside cavity and provided on the earphone casing, an independent sound guiding cavity arranged in the inside cavity, wherein an opening of the sound guiding cavity is arranged toward the sound output port; a dynamic unit component comprising a dynamic speaker arranged in the inside cavity, where the sound output direction of the dynamic speaker is set towards the sound output port; a high-frequency unit component comprising a high-frequency speaker arranged in the sound guiding cavity, where the sound output direction of the high-frequency speaker is set towards the sound output port.

### CROSS-REFERENCE TO RELATED APPLICATION(S)

This application claims the benefit of Chinese Patent Application Serial No. 202421196853.2, entitled “HYBRID DUAL UNIT EARPHONE” and filed on May 29, 2024, which is expressly incorporated by reference herein in its entirety.

### BACKGROUND

### Field

The present invention is related to the field of earphone devices, especially a hybrid dual unit earphone.

### Background

The common commercial earphones can be divided into the following categories based on their contact type with human ears: open-type, flat-head non-in-ear type, semi-in-ear type, in-ear type, on-ear type, over-ear type, etc. These earphones are different in shape and may be characterized in terms of comfort, sound quality, privacy, etc.

At present, for open-type earphones, a single dynamic open-type is more commonly adopted in acoustic design, which focuses more on improving low frequencies while neglecting or being unable to take into account the details of high frequencies, resulting in poor high-frequency output of open-type earphones on the market. Hence, the overall output performance of open-type earphones often cannot meet the requirements of users.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

A purpose of this disclosure is to provide a hybrid dual unit earphone, which can balance the output of each of frequency bands such as a high frequency band and a low frequency band, effectively improve the performance and quality of output audio, and enhance the user experience.

The following technical solution may be adopted by the present disclosure to achieve the above purpose:

A hybrid dual unit earphone is provided.

The hybrid dual unit earphone may include an earphone casing, an inside cavity arranged in the earphone casing, a sound output port configured to communicate with the inside cavity and provided on the earphone casing, an independent sound guiding cavity arranged in the inside cavity, wherein an opening of the sound guiding cavity is arranged toward the sound output port;

The hybrid dual unit earphone may further include a dynamic unit component comprising a dynamic speaker arranged in the inside cavity, wherein the dynamic speaker is arranged to set a sound output direction of the dynamic speaker towards the sound output port;

The hybrid dual unit earphone may further include a high-frequency unit component comprising a high-frequency speaker arranged in the sound guiding cavity, wherein the high-frequency speaker is arranged to set a sound output direction of the high-frequency speaker towards the sound output port.

In one aspect, the hybrid dual unit earphone may further include a baffle plate is provided in the earphone casing, wherein a side of the baffle plate away from the inside cavity is bent to form the sound guiding cavity, and a through-hole communicating the inside cavity, where the sound output port is provided on the baffle plate.

In one aspect, the dynamic speaker and the high-frequency speaker are not arranged coaxially, and the sound guiding cavity and the through-hole are arranged side by side on the baffle plate.

In one aspect, the hybrid dual unit earphone may further include a sound output tuning screen provided on the sound output port, wherein the dynamic speaker is arranged to set the sound output direction of the dynamic speaker towards the sound output tuning screen.

In one aspect, the hybrid dual unit earphone may further include a front sound tuning screen provided at one end of the high-frequency speaker toward the sound output port, and a rear sound tuning screen provided at another end of the high-frequency speaker toward the inside cavity.

In one aspect, the hybrid dual unit earphone may further include a protective screen provided on the sound output port, where the protective screen is arranged on a side of the sound output tuning screen and the front sound tuning screen spaced apart from the inside cavity.

In one aspect, the hybrid dual unit earphone may further include a face cover provided on one end of the inside cavity away from the sound output port, wherein the face cover is detachably connected to the earphone casing.

In one aspect, the hybrid dual unit earphone may further include a plurality of leakage holes arranged to communicate with the inside cavity and provided on the earphone casing.

In one aspect, the hybrid dual unit earphone may further include a plurality of leakage hole sound tuning screens respectively provided on the plurality of leakage holes.

In one aspect, the plurality of leakage holes include a plurality of lateral leakage holes and at least one top leakage hole, where the plurality of lateral leakage holes are arranged on a lateral wall of the earphone casing, and the at least one top leakage hole is arranged on the face cover.

The benefits of the present disclosure may include:

According to the hybrid dual unit earphone in the present disclosure, an inside cavity and an independent sound guiding cavity are arranged in the earphone casing, a dynamic speaker is provided in the inside cavity and the sound output direction of the dynamic speaker is set towards the sound output port, where the dynamic speaker is responsible for the output of the middle-to-low frequency part of sound from open type earphone, a high-frequency speaker is provided in the sound guiding cavity and the sound output direction of the high-frequency speaker is set towards the sound output port, where the high-frequency speaker is responsible for the output of the high-to-ultra high frequency part of sound. As such, the earphone can balance the output of each frequency band such as a high frequency band and a low frequency band, effectively improve the performance and quality of output audio, and enhance the user experience.

Furthermore, the dynamic speaker and the high-frequency speaker are arranged in two cavities respectively, which avoid mutual interference between high-frequency sound and low-frequency sound of the sound output to a certain extent, it is favorable for improving sound separation, ensuring the sound quality and performance of sound output, and enhancing the user experience.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a structural diagram of a hybrid dual unit earphone, according to some aspects;

FIG. 2 is a partial structural diagram of the hybrid dual unit earphone, according to some aspects;

FIG. 3 is an exploded structural diagram of the hybrid dual unit earphone, according to some aspects;

FIG. 4 is a partial sectional view of the hybrid dual unit earphone, according to some aspects;

FIG. 5 is an enlarged structural diagram of part A in FIG. 4, according to some aspects.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. It also should be noted that, for convenience of description, in accompanying drawing, illustrate only the part relevant to the concepts but not the entire structure.

In the present disclosure, unless otherwise clearly stated and limited, terms “join”, “connect” and “fix” should be understood broadly. For instance, it can be a fixed connection, a detachable connection or an integral connection; can be a mechanical connection, also can be an electrical connection; can be a direct connection, can also be an indirect connection by an intermediary, can be an internal communication of two elements. A person skilled in the art can understand concrete meanings of the terms in the present disclosure as specific circumstances.

In the present disclosure, unless otherwise clearly specified and limited, a first feature being “on” or “under” a second feature may include direct contact between the first and second features, and may also include the first and second features not in direct contact but through another characteristic contact between them. Moreover, the first feature being “on” the second feature may include the first feature being directly above and obliquely above the second feature, or may simply mean that the first feature is horizontally higher than the second feature. The first feature “below” the second feature may mean that the first feature is directly below and obliquely below the second feature, or may simply mean that the level of the first feature is lower than that of the second feature.

It should be noted that, in the description of the present application, the term “up”, “down”, “right”, “left”, and other indicated direction or position relationship is based on the direction or position relationship shown in the accompanying drawings, which is only intended to describe the present application and simplify descriptions, and not to indicate or imply that the apparatus or elements must have a specific orientation, structured and operated in a particular orientation, and therefore cannot be construed as a limitation of the present disclosure. Furthermore, the terms “first” and “second” are used only for descriptive purposes and are not intended to have a special meaning.

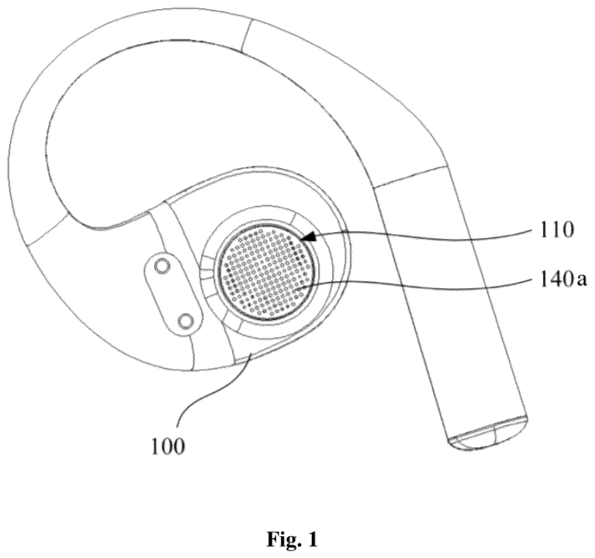

As shown in FIG. 1 to FIG. 5, a hybrid dual unit earphone is provided. FIG. 1 is a structural diagram of a hybrid dual unit earphone, according to some aspects. In particular, FIG. 1 shows the hybrid dual unit in an assembled form. As shown in FIG. 1, the hybrid dual unit earphone includes an earphone casing 100 and a sound output port 110 through which sound is output. Further, as shown in FIG. 1, a protective screen 140a is further provided on the sound output port 110.

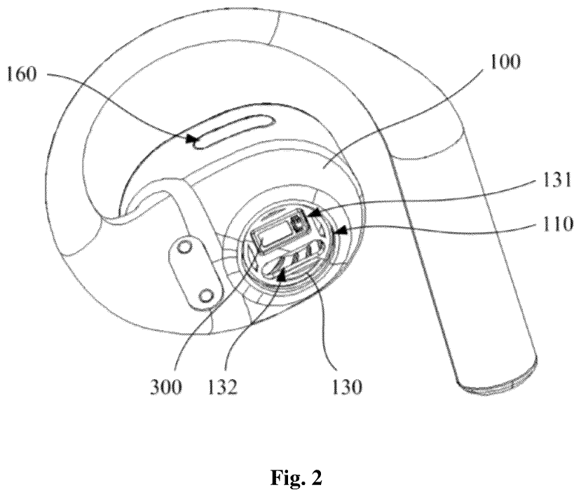

FIG. 2 is a partial structural diagram of the hybrid dual unit earphone, according to some aspects. For example, FIG. 2 may be a partial structural diagram of the hybrid dual unit earphone of FIG. 1. In particular, FIG. 2 shows the partial structural diagram of the hybrid dual unit without the protective screen 140a, and thus showing components of the hybrid dual unit earphone that are visible when the protective screen 140a is not present. FIG. 2 shows that the hybrid dual unit earphone further includes a sound guiding cavity 131 having an opening towards the sound output port 110 and having a high-frequency speaker 300, a through-hole 132, and a baffle plate 130. FIG. 2 further shows one of multiple leakage holes 160.

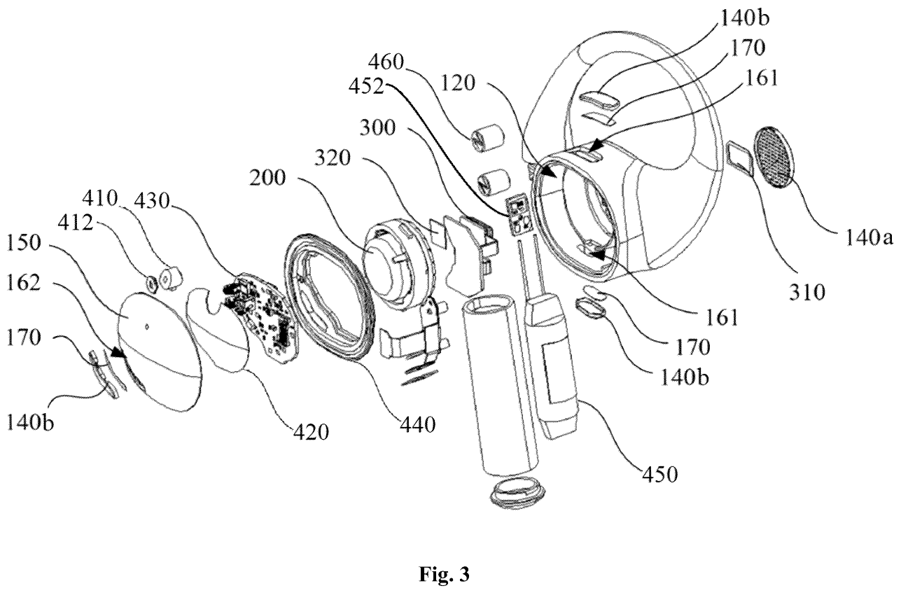

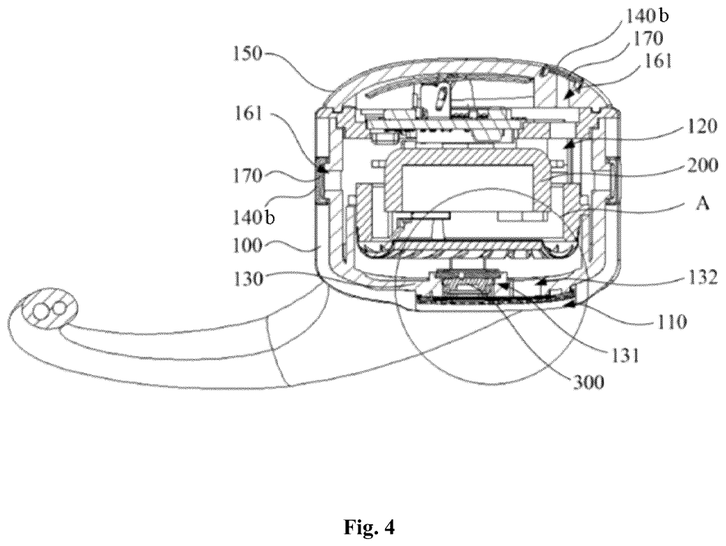

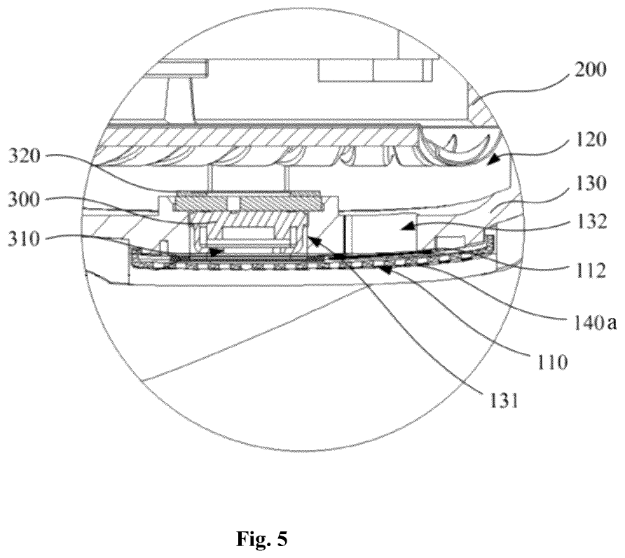

FIG. 3 is an exploded structural diagram of the hybrid dual unit earphone, according to some aspects. For example, FIG. 3 may be an exploded structural diagram of the hybrid dual unit earphone of FIG. 1 and/or FIG. 2. FIG. 4 is a partial sectional view of the hybrid dual unit earphone, according to some aspects. For example, FIG. 4 may be a partial sectional view of the hybrid dual unit earphone of FIG. 1 and/or FIG. 2. FIG. 5 is an enlarged structural diagram of part A in FIG. 4, according to some aspects. The features of the hybrid dual unit earphone shown in FIG. 1 to FIG. 5 are described in more detail below.

The hybrid dual unit earphone includes the earphone casing 100, an inside cavity 120 arranged in the earphone casing 100, the sound output port 110 configured to communicate with the inside cavity 120 and provided on the earphone casing 100, the sound guiding cavity 131 arranged in the inside cavity 120 and independent from the inside cavity 120. For example, the sound guiding cavity 131 may be separately formed from the inside cavity 120. In an aspect, an opening of the sound guiding cavity 131 is arranged toward the sound output port 110. For example, as shown in FIG. 3, the inside cavity may form a hollow space in the interior of the earphone casing 100, so as to fit various components of the earphone therein. The sound guiding cavity 131 is a separate structure from the inside cavity 120.

The hybrid dual unit earphone further includes a dynamic unit component. The dynamic unit component includes a dynamic speaker 200 arranged in the inside cavity 120, where the dynamic speaker 200 is arranged to set the sound output direction of the dynamic speaker 200 toward the sound output port 110. For example, as shown in FIG. 3 and FIG. 4, the dynamic speaker 200 is arranged in the interior of the inside cavity 120 such that the sound output direction of the dynamic speaker 200 faces toward the sound output port 110.

The hybrid dual unit earphone further includes a high-frequency unit component. The high-frequency unit component includes the high-frequency speaker 300 in the sound guiding cavity 131, where the high-frequency speaker 300 is arranged to set the sound output direction of the high-frequency speaker 300 toward the sound output port 110. For example, as shown in FIG. 2 and FIG. 4, the high-frequency speaker 300 is arranged in the interior of the sound guiding cavity 131 such that the sound output direction of the high-frequency speaker 300 faces toward the sound output port 110.

In this aspect, the inside cavity 120 and the sound guiding cavity 131 are arranged in the earphone casing 100, the dynamic speaker 200 is provided in the inside cavity 120 and the dynamic speaker 200 is arranged to set the sound output direction of the dynamic speaker towards the sound output port 110, where the dynamic speaker 200 is responsible for the output of the middle to low frequency part of sound from an open-type earphone, and a high-frequency speaker 300 is provided in the sound guiding cavity 131 and the high-frequency speaker 300 is arranged to set the sound output direction of the high-frequency speaker 300 towards the sound output port 110, where the high-frequency speaker 300 is responsible for the output of the high to ultra-high frequency part of sound. For example, the low frequency part may have a range of 20 Hz-250 Hz and the middle frequency part may have a range of 250 Hz-2500 Hz, while the high frequency part may have a range of 2500 Hz-20000 Hz and the ultra-high frequency part may be above 20000 Hz. As such, the quality of the sound from the sound guiding cavity 110 can balance the output of each of frequency bands such as a high frequency band (e.g., 2500 Hz-20000 Hz) and a low frequency band (e.g., 20 Hz-250 Hz), effectively improve the performance and quality of output audio, and enhance the user experience. For example, open-type earphones generally lack sufficient high and low-frequency extensions. This issue is effectively addressed by using a two-way design with the dynamic speaker 200 for deep bass (e.g., for the low frequency band) and the high-frequency speaker 300 for extended highs (e.g., for the high frequency band).

Furthermore, the dynamic speaker 200 and the high-frequency speaker 300 are arranged in two different cavities (e.g., the inside cavity 120 and the sound guiding cavity 131) respectively, which avoid mutual interference between high-frequency sound and low-frequency sound of the sound output to a certain extent. Hence, it is favorable for improving sound separation, improving the sound quality and performance of the sound output, and enhancing the user experience.

In practice, the high-frequency speaker 300 may be a micro-electro-mechanical systems (MEMS) speaker, which is generally small in size and thin in thickness. It is easy to output sound from the sound guiding cavity 131 that is directional toward the sound output port 110, which is conducive to reducing the overall volume, height, and thickness of the earphone, avoiding problems such as adversely affecting the appearance of the earphone or wearing of the earphone.

In general, the open-type earphones that only adopt dynamic units begin to attenuate at 6-7 kHz. In the hybrid dual unit earphone according to some aspects, the dynamic speaker 200 is combined with the high-frequency speaker 300 that may be the MEMS speaker to greatly expand the bandwidth on the open-type earphone. With this approach, it is verified that a high frequency can reach 30 kHz, and details at high-frequency are rich and delicate.

In one aspect, the baffle plate 130 is provided in the earphone casing 100, where the side of the baffle plate 130 facing away from the inside cavity 120 is bent to form the sound guiding cavity 131. Further, the through-hole 132 for communicating with the inside cavity 120 with the sound output port 110 is provided on the baffle plate 130, so that the sound from the dynamic speaker 200 arranged in the inside cavity 120 can be output via the through-hole 132. For example, as shown in FIG. 4 and FIG. 5, portions of the baffle plate 130 are bent to form the sound guiding cavity 131, and the through-hole 130 is provided at the baffle plate, such that air or sound may travel between the inside cavity 120 and the outside through the sound output port 110.

In one aspect, the dynamic speaker 200 and the high-frequency speaker 300 may not be arranged coaxially, and the sound guiding cavity 131 and the through-hole 132 may be arranged side by side on the baffle plate 130. and thus the direction of the sound output from the dynamic speaker 200 through the through-hole 132 and the direction of the sound output from the high-frequency speaker 300 in the sound guiding cavity 131 are not on the same axis. As such, the mid-to-low frequency part of the sound output by the dynamic speaker 200 and the high-frequency part of the sound output by the high-frequency speaker 300 do not interfere with each other, which can effectively improve the sound separation and ensure the performance and quality of the sound, and improve the user's experience. For example, as shown in FIG. 3, an axis through a center of the dynamic speaker 200 is different from an axis through a center of the high-frequency speaker 300. Further, for example, as shown in FIG. 4, the sound guiding cavity 131 and the through-hole 132 are arranged next to each other on the baffle plate 130, such that the direction of the sound output from the dynamic speaker 200 is on a different axis from an axis corresponding to the direction of the sound output from the high-frequency speaker 300.

In one aspect, a sound output tuning screen 112 is provided on one end of the sound output port 110 away from the baffle plate 130, where the dynamic speaker 200 is arranged to set the sound output direction of the dynamic speaker 200 towards the sound output tuning screen 112, and the sound output of the dynamic speaker 200 can be adjusted through the sound output tuning screen 112 to avoid output sound turbidity. Specifically, by adjusting the size and the shape of the sound output tuning screen 112 according to different types of processing and different user needs, the frequency of sound can be changed to a certain extent, thereby enhancing certain frequency bands and/or reducing others, and improving the pertinence and adaptability of the entire earphone device.

In one aspect, a front sound tuning screen 310 is provided at one end of the high-frequency speaker 300 toward the sound output port 110, and a rear sound tuning screen 320 is provided at another end of the high-frequency speaker 300 toward the inside cavity 120. For example, as shown in FIG. 3, the front sound tuning screen 310 is provided at one side of the high frequency speaker 300 facing the sound output port 110 while the rear sound tuning screen 320 is provided at another side of the high frequency speaker 300 facing away from the sound output port 110. In this aspect, because the high-frequency speaker 300 and the dynamic speaker 200 are arranged independently from each other, the high-frequency speaker 300 can be adjusted separately, which may include adjusting the polarity of the high-frequency speaker 300, the damping of the front sound tuning screen 310 and the rear sound tuning screen 320, and/or amplification of a power amplifier for the earphone. A frequency dividing circuit is not required to achieve a natural connection with the sound of the dynamic speaker 200, so as to obtain a balanced and extended high frequency sound quality, which is simple and convenient to operate.

In one aspect, the protective screen 140a is further provided on the sound output port 110, and the protective screen 140a is arranged on the side of the sound output tuning screen 112 and the front sound tuning screen 310 away from the inside cavity 120, which separates the sound output tuning screen 112 from the outside and protects the sound output tuning screen 112. At the same time, the sound guiding cavity 131 and the high-frequency speaker 300 arranged in the sound guiding cavity 131 can be effectively protected by the protective screen 140a. For example, as shown in FIG. 3 and FIG. 5, the protective screen 140a may be provided on the sound output port 110 to provide some protection for components within the interior portion of the sound output port 110. In some aspects, the protective screen 140a may be made of metal. For example, the protective screen 140a may include a steel screen, which has the advantages of high strength, easy processing, and high stability. Of course, in addition to this example, other metal materials, such as copper, copper alloy, aluminum alloy, etc. can also be utilized for the protective screen 140a, and such designs fall within the scope of the present disclosure.

In an aspect, a face cover 150 is provided on one end of the inside cavity 200 away from the sound output port 110, where the face cover 150 is detachably connected to the earphone casing 100. By detaching the face cover 150, it is easy to isolate the internal components in the earphone casing 100 from outside and facilitate maintenance and other operations on the internal components in the earphone casing 100. For example, as shown in FIG. 3, the face cover 150 may be provided at a side of the dynamic speaker 200 that is facing away from the sound output port 110.

In one aspect, at least one leakage hole 160 which communicates with inside cavity 120 is further provided on the earphone casing 100 to maintain an air pressure balance in the inside cavity 120. When the dynamic speaker 200 plays sound, sound waves are generated, which creates a pressure in the inside cavity 120. Through the leakage hole 160, at least some of the air in the inside cavity 120 is allowed to flow out of the inside cavity 120, thereby maintaining a stable air pressure inside the inside cavity 120 and thus avoiding an impact of a high pressure on the sound quality, and also helping to improve the bass effect of the dynamic speaker 200.

In one aspect, leakage hole sound tuning screens 170 are respectively provided on the leakage holes 160, so as to adjust the sound more accurately and avoid sound became murky. The leakage holes 160 include lateral leakage holes 161, which are provided on the lateral wall of the earphone casing 100. For example, as shown in FIG. 3 and FIG. 4, there are two lateral leakage holes 161, which are respectively provided on the two opposite lateral walls of the earphone casing 100. The leakage holes 160 are helpful for maintaining stable air pressure in the inside chamber 120, thereby improving sound quality.

Furthermore, in an aspect, the leakage holes 160 further include at least one top leakage hole 162, which is provided on the face cover 150. As the face cover 150 faces away from the human ear when the earphone is worn, there is no obstruction on the side of the at least one top leakage hole 162 facing the outside, making it easier for the air to flow from the inside the cavity 120 to the outside. Moreover, the at least one top leakage hole 162 is arranged distant and apart from a human body when the earphone is worn (e.g., avoiding human contact), and the air temperature on the side of the at least one top leakage hole 162 is lower, which is conducive to causing the air to flow from the inside cavity 120 to the outside through the at least one top leakage hole 162. For example, as shown in FIG. 3, the at least one top leakage hole 162 is located on a side of the earphone that does not contact the human ear. For example, the temperature on the side of the least one leakage hole 162 is lower than the temperature on the side of the outlet hole 110 because the outlet hole 110 is close to a human body (e.g., ear) that can contribute to a higher temperature to the side of the outlet hole 110 when the earphone is worn.

In an aspect, multiple protective screens 140b are provided respectively for the leakage holes 160 including the lateral leakage holes 161 and the at least one top leakage hole 162 to protect the leakage hole sound tuning screens 170 and effectively isolate the inside from the outside of the earphone casing 100, thereby preventing dust and debris from entering the earphone casing 100 and protecting the components inside the earphone casing 100 from damages. In some aspects, the protective screens 140b may be made of metal.

The example shown in FIG. 3 further illustrates various other components for the hybrid dual unit earphone. For example, as shown in FIG. 3, the earphone may include a microphone boot 410 and a microphone mesh 412 to cover the microphone boot 410. The earphone may further include an antenna flexible printed circuit (FPC) 420 configured to communicate wireless signals, a main printed circuit board assembly (PCBA) 430 for controlling various features of the earphone and a bracket 440 to provide support for the main PCBA 430 and seal the inside cavity 120, as shown in FIG. 3. In addition, as shown in FIG. 3, the earphone may include a battery 450 to power the earphone, and a battery PCBA 452 for controlling the battery, and one or more magnets 460.

It should be understood that the above-described features of the present disclosure are merely examples for clearly illustrating the present disclosure, and are not intended to limit the features of the present disclosure. It will be readily apparent to those skilled in this art that various modifications, rearrangements and substitutions can be made without departing from the spirit of the present disclosure. It is not necessary and impossible to exhaustively list all implementation manners here. Any modification, equivalent replacement, and improvement made within the spirit and principle of the present disclosure should be included in the protection scope of the claims of the present disclosure.

What is claimed is:

1. A hybrid dual unit earphone, comprising:
an earphone casing;
an inside cavity arranged in the earphone casing;
a sound output port configured to communicate with the inside cavity and provided on the earphone casing;
an independent sound guiding cavity arranged in the inside cavity, wherein an opening of the sound guiding cavity is arranged toward the sound output port;
a dynamic unit component comprising a dynamic speaker arranged in the inside cavity, wherein the dynamic speaker is arranged to set a sound output direction of the dynamic speaker towards the sound output port; and
a high-frequency unit component comprising a high-frequency speaker arranged in the sound guiding cavity, wherein the high-frequency speaker is arranged to set a sound output direction of the high-frequency speaker towards the sound output port.

2. The hybrid dual unit earphone of claim 1, further comprising:
a baffle plate provided in the earphone casing, wherein a side of the baffle plate away from the inside cavity is bent to form the sound guiding cavity; and
a through-hole for communicating with the inside cavity,
wherein the sound output port is provided on the baffle plate.

3. The hybrid dual unit earphone of claim 2, wherein the dynamic speaker and the high-frequency speaker are not arranged coaxially, and
wherein the sound guiding cavity and the through-hole are arranged side by side on the baffle plate.

4. The hybrid dual unit earphone of claim 1, further comprising:
a sound output tuning screen provided on the sound output port, wherein the dynamic speaker is arranged to set the sound output direction of the dynamic speaker towards the sound output tuning screen.

5. The hybrid dual unit earphone of claim 4, further comprising:
a front sound tuning screen provided at one end of the high-frequency speaker toward the sound output port; and
a rear sound tuning screen provided at another end of the high-frequency speaker toward the inside cavity.

6. The hybrid dual unit earphone of claim 5, further comprising:
a protective screen provided on the sound output port,
wherein the protective screen is arranged on a side of the sound output tuning screen and the front sound tuning screen spaced apart from the inside cavity.

7. The hybrid dual unit earphone of claim 1, further comprising:
a face cover provided on one end of the inside cavity away from the sound output port, wherein the face cover is detachably connected to the earphone casing.

8. The hybrid dual unit earphone of claim 7, further comprising a plurality of leakage holes arranged to communicate with the inside cavity and provided on the earphone casing.

9. The hybrid dual unit earphone of claim 8, further comprising a plurality of leakage hole sound tuning screens respectively provided on the plurality of leakage holes.

10. The hybrid dual unit earphone of claim 8, wherein the plurality of leakage holes include a plurality of lateral leakage holes and at least one top leakage hole, and
wherein the plurality of lateral leakage holes are arranged on a lateral wall of the earphone casing, and the at least one top leakage hole is arranged on the face cover.
